(19) United States
(12) Patent Application Publication
(10) Pub. No.: US 2004/0146119 A1
(43) Pub. Date: Jul. 29, 2004

(54) Receiver

(75) Inventors: Nicholas Henry Weiner, Bristol (GB); Paul A. Denny, Bristol (GB); Benjamin A. Willcocks, Bristol (GB); Paul Wilson, Bristol (GB)

Correspondence Address: LAHIVE & COCKFIELD, LLP., 28 STATE STREET, BOSTON, MA, 02109, US

(73) Assignee: Phyworks Limited, Bristol (GB)

(21) Appl. No.: 10/610,778

(22) Filed: Jun. 30, 2003

(30) Foreign Application Priority Data
Jun. 2, 2003 (GB) 0312593.7
Jan. 28, 2003 (GB) 0301953.6

(51) Int. Cl. H04L 25/06; H04L 25/10

(52) U.S. Cl. 375/317

(57) ABSTRACT

A method is disclosed for recovering a digital signal from an analog signal. A received analog signal value is compared with a centre threshold, and with at least one of a pair of outer thresholds, to form comparator output signals. Digital samples of the comparator output signals are formed using a recovered clock signal. The values of the outer thresholds are adapted such that a constant proportion of the digital samples represent received signal values lying between the outer thresholds, and the phase of the recovered clock signal is adapted such that the separation of the outer thresholds is maximised. Other receiver parameters can be adapted in the same way.

### TECHNICAL FIELD OF THE INVENTION

This invention relates to a receiver, and in particular to a receiver, which includes a means for monitoring the quality of a received signal.

### BACKGROUND OF THE INVENTION

In a conventional digital data transmission system, a sequence of data bits is transmitted over a communications medium. A receiver then attempts to recreate the transmitted sequence. That is, for each received bit, the receiver determines whether the transmitted bit is more likely to have been a “1” or a “0”. In doing so, the receiver must deal with the fact that the received signal will not be a perfect copy of the transmitted bit sequence, but will show the effects of changes to the waveform introduced by the communications medium, and will include an additional noise component.

As mentioned above, for each received bit, the receiver determines whether the transmitted bit is more likely to have been a “1” or a “0”.

This determination must be made on the basis of limited information available in the receiver. For example, the beginning and end of each bit period are not necessarily apparent from the received waveform itself.

### SUMMARY OF THE INVENTION

According to a first aspect of the present invention, there is provided a method of detecting a received signal in a receiver, the method comprising:

recovering a clock signal;

comparing the received signal with a centre threshold, and with at least one of a pair of outer thresholds;

forming digital samples of the received signal using the recovered clock signal;

adapting the values of the outer thresholds such that a constant proportion of the digital samples lie between the outer thresholds; and

adapting,a receiver parameter such that a separation of the outer thresholds is maximised.

This has the advantage that the separation of the outer thresholds is a measure of the signal quality, which can be derived easily from measurements which are available in the receiver. This measure of the signal quality can then be used in any adaptation algorithm or feedback loop to control any receiver parameter. Changes to a receiver parameter which improve the signal quality will also tend to increase the separation of the outer thresholds. Therefore, choosing a value for a receiver parameter, in order to maximise the separation of the outer thresholds, will result in improved received signal quality.

According to a second aspect of the present invention, there is provided a receiver which is adapted to operate in accordance with the method of the first aspect.

### BRIEF DESCRIPTION OF DRAWINGS

FIG. 1 is a block schematic diagram of a receiver in accordance with an aspect of the present invention.

FIG. 2 shows the distribution of signal values at a point in the receiver of FIG. 1.

FIG. 3 is a flow chart, illustrating a method in accordance with the invention.

FIG. 4 is a block diagram of a receiver in accordance with a second embodiment of the present invention.

### DETAILED DESCRIPTION OF PREFERRED EMBODIMENTS

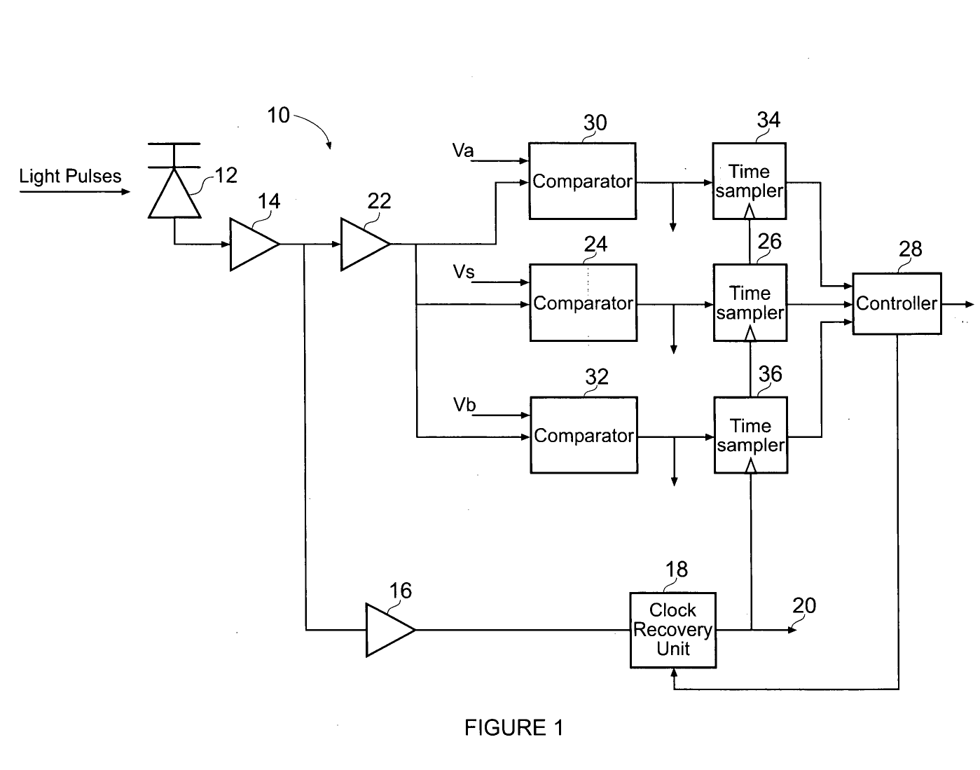

FIG. 1 shows a part of a receiver device 10. In this illustrated embodiment of the invention, the receiver is intended for use in an optical communications system, in which optical signals are transmitted at high data rates, for example of the order of 10 Gb/s. As shown in FIG. 1, light pulses are received at a photo-detector 12, which converts the received light pulses into an analog electrical signal.

The analog electrical signal is passed to a pre-amplifier 14, and the resulting pre-amplified signal is passed to a limiting amplifier 16, which effectively acts as an analog-digital converter, and then to a clock recovery circuit 18. For the purposes of describing the present invention, the clock recovery circuit may operate in a conventional way, and the operation thereof will not be described further here. The purpose of the clock recovery circuit 18 is to provide a recovered clock signal at the same frequency as the transmitted waveform. The recovered clock signal is supplied to a clock output 20, and is also used to sample the received signal, as will be described in more detail below.

The output signal from the pre-amplifier 14 is also passed to a linear amplifier 22.

It should also be noted that, in cases where inter-symbol interference (ISI) is particularly severe, the amplifier 22 may usefully be replaced by an equalizer, which can compensate for the effects of ISI, as is known in the art.

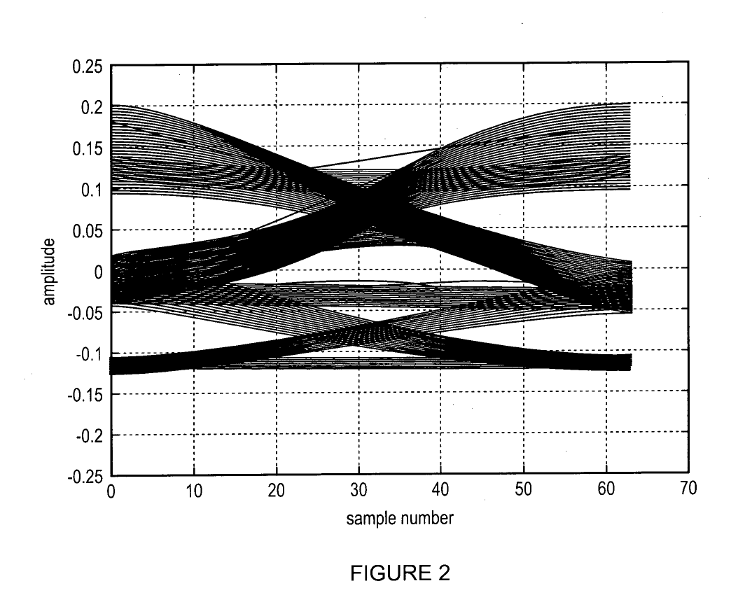

FIG. 2 is an “eye diagram”, which shows the form of the signal output from the amplifier 22.

Specifically, for a large number of bit periods, the signal value has been sampled at a number of sampling points, and the trajectories, taken by the signal value during those bit periods, have been superimposed on each other to form the eye diagram of FIG. 2.

Although, in the ideal case, the signal value should take a high value during some bit periods and a low value during other bit periods, it is clear from FIG. 2 that an actual situation may be far from ideal.

The presence of ISI, and noise, together mean that, during one bit period, the received signal value varies. More specifically, the received signal value will be influenced not only by the transmitted signal during that bit period, but also by the transmitted signal during adjacent bit periods, and will also be influenced randomly by noise.

The signal output from the amplifier 22 is supplied to one input of a comparator 24, and a signal having a predetermined level Vs is supplied to the other input of the comparator 24.

The output of the comparator 24 is therefore high when the output from the amplifier 22 is higher than the predetermined level Vs, and is low when the output from the amplifier 22 is lower than the predetermined level Vs.

The output from the comparator 24 is then supplied to a time sampler 26, which receives the clock signal from the clock recovery unit 18. Based on the clock signal, the time sampler 26 then forms one sample of the output from the comparator 24 for each bit period in the received signal.

The output from the time sampler 26 is then a binary data stream, having the required frequency, in which each bit represents the initial estimate of the transmitted value for that bit period. The output from the time sampler 26 is supplied to a controller 28, and then to a circuit output, where it can be used in other receiver circuits.

The predetermined level Vs therefore forms a centre threshold. A binary “1” is output if the received value is above the threshold at the sampling point in each bit period, and a binary “0” is output if the received value is below the threshold at the sampling point in each bit period. The predetermined level Vs is also referred to as the “slice level”.

It can be appreciated from FIG. 2 that the selection of the sampling point will have a significant effect on whether the sampled value is a binary “1” or a binary “0”. In general terms, choosing a sampling point close to the centre of the bit period will allow the distinction to be made between binary “1”s and binary “0”s more accurately than a sampling point nearer the beginning or the end of the bit period.

However, in the absence of an externally defined clock signal, it is not trivial to determine the optimum position.

According to the preferred embodiment of the present invention, the signal output from the amplifier 22 is also supplied to a first input of a second comparator 30, and to a first input of a third comparator 32. A signal having a second predetermined level Va is supplied to the second input of the second comparator 30, and a signal having a third predetermined level Vb is supplied to the second input of the third comparator 32.

The output of the comparator 30 is therefore high when the output from the amplifier 22 is higher than Va, and is low when the output from the amplifier 22 is lower than Va, and the output of the comparator 32 is high when the output from the amplifier 22 is higher than Vb, and is low when the output from the amplifier 22 is lower than Vb.

The output from the comparator 30 is then supplied to a time sampler 34, which receives the clock signal from the clock recovery unit 18. Based on the clock signal, the time sampler 34 then forms one sample of the output from the comparator 30 for each bit period in the received signal. Similarly, the output from the comparator 32 is supplied to a time sampler 36, which also receives the clock signal from the clock recovery unit 18. Based on the clock signal, the time sampler 36 forms one sample of the output from the comparator 32 for each bit period in the received signal

As mentioned above, the slice level Vs forms a centre threshold, and the controller 28 makes an initial estimate, as to whether the received signal represents a binary “0” or a binary “1”, based on the comparison between the received signal value and Vs.

The comparator 24 therefore enables a polarity decision regarding the received bit.

The reference input Va is an upper outer threshold, and the reference input Vb is a lower outer threshold. The values of the upper outer threshold Va and the lower outer threshold Vb are set by the controller 28 such that a predetermined, small, percentage, for example 10%, of bits lie between them.

As mentioned above, a polarity decision is made, based on the output from the comparator 24. Also, a confidence decision may be made, based on the outputs from the comparators 30, 32. That is, for bits which lie between the upper outer threshold Va and the lower outer threshold Vb, the polarity decision is made with low confidence, while, for bits which are higher than the upper outer threshold Va or lower than the lower outer threshold Vb, the polarity decision is made with high confidence.

For each received bit, the controller 28 can therefore provide a two-bit output, representing the polarity decision, and a confidence bit which indicates whether the polarity decision is made with high or low confidence.

The outputs from the controller 28 can then be used further, for example in an error correction algorithm.

However, in accordance with the present invention, the controller 28 also acts to adjust the phase of the clock signal formed by the clock recovery unit 18, and hence the sampling points used by the time samplers 26, 34, 36.

Specifically, the values of the upper outer threshold Va and the lower outer threshold Vb are adjusted, in order to maintain the predetermined, small, percentage of bits representing signal values lying between the upper outer threshold Va and the lower outer threshold Vb. For example, Va may be set such that 45% of samples represent signal values lying above Va, and Vb may be set such that 45% of samples represent signal values lying below Vb, thus ensuring that a constant 10% of samples represent signal values lying between Va and Vb.

Then, the degree of separation of the upper outer threshold Va and the lower outer threshold Vb (that is, Va−Vb) can be used as a measure of the quality of the time sampled signal.

It can be seen from FIG. 2 that, if the sampling point were to be set close to the centre of the bit period, there would be a gap in the centre of the amplitude range containing relatively few samples. By contrast, if the sampling point were to be set away from the centre of the bit period, the gap containing relatively few samples would be much narrower.

The degree of separation (Va−Vb) can then be used in a feedback control loop to adjust the phase of the clock signal formed by the clock recovery unit 18.

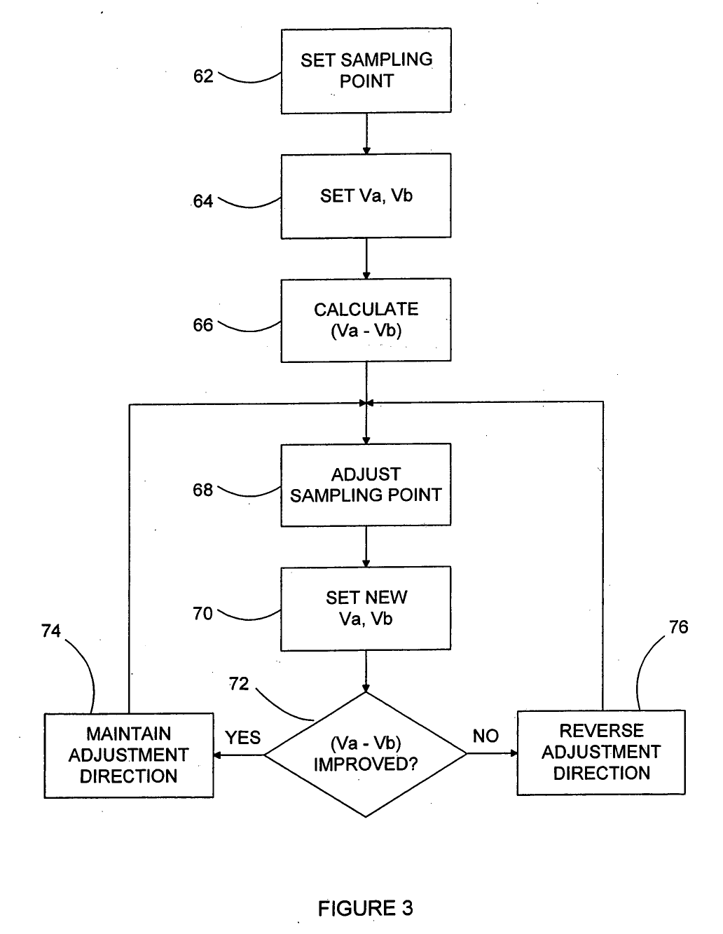

FIG. 3 is a flow chart, showing the control method in accordance with the invention. Specifically, in step 62 a sampling point, and hence a particular phase of the clock signal formed by the clock recovery unit 18, is set. Then Va and Vb are set in step 64, such that the desired fixed percentage of samples represent signal values lying between them, and (Va−Vb) is calculated in step 66. Then, in step 68 the sampling point can be moved, either forwards or backwards within the bit period, and new values of Va and Vb can be set in step 70. In step 72, it is determined whether the resulting new value of (Va−Vb) is an improvement over the previously calculated value. That is, since the magnitude of (Va−Vb) can be used as a measure of the quality of the time sampled signal, it is determined whether the resulting new value of (Va−Vb) is larger than the previously calculated value.

If it is determined in step 72 that the new value of (Va−Vb) is an improvement over the previously calculated value, the process passes to step 74, in which the direction of movement of the sampling point is maintained, and then returns to step 68, in which the sampling point is again moved. As mentioned above, the sampling point could have been moved either forwards or backwards within the bit period in the previous iteration, and the same direction is used in this iteration.

However, if it is determined in step 72 that the new value of (Va−Vb) is worse than the previously calculated value, the process passes to step 76, in which the direction of movement of the sampling point is reversed, and then returns to step 68, in which the sampling point is again moved. In this event, the sampling point is moved in the opposite direction to that used in the previous iteration.

The sampling point is therefore continuously adjusted around the optimum position. It will be appreciated that other feedback control schemes could also be used to adjust the sampling position based on the separation of the upper and lower outer thresholds.

Although the controller 28 has been illustrated herein as a hardware device, it will be appreciated by the person skilled in the art that the control processes may be carried out in hardware, or in software, or in any combination thereof.

The illustrated embodiment of the invention is a soft-decision receiver, having two comparators 30, 32, allowing the formation of a confidence bit in association with each bit in the received signal. However, in another embodiment of the invention, the comparators 30, 32 could be replaced by a single comparator, which compares the received signal value with an upper outer threshold for a part of the time, and with a lower outer threshold for another part of the time.

The value of the upper outer threshold Va can then be adjusted during the period while the received signal value is being compared with it, such that 45% of samples lie above Va, and the value of the lower outer threshold Vb can be adjusted during the period while the received signal value is being compared with it, such that 45% of samples lie below Vb, and the degree of separation of the upper outer threshold Va and the lower outer threshold Vb (Va−Vb) can be calculated using the most recently set values of Va and Vb.

Thus, the invention has been described above with reference to an exemplary embodiment, in which the separation of the outer thresholds is used as a measure of quality of the sampled signal, and is used to control the phase of the recovered clock signal.

However, other receiver parameters can be adjusted in the same or similar ways, again in order to maximise the separation of the outer thresholds.

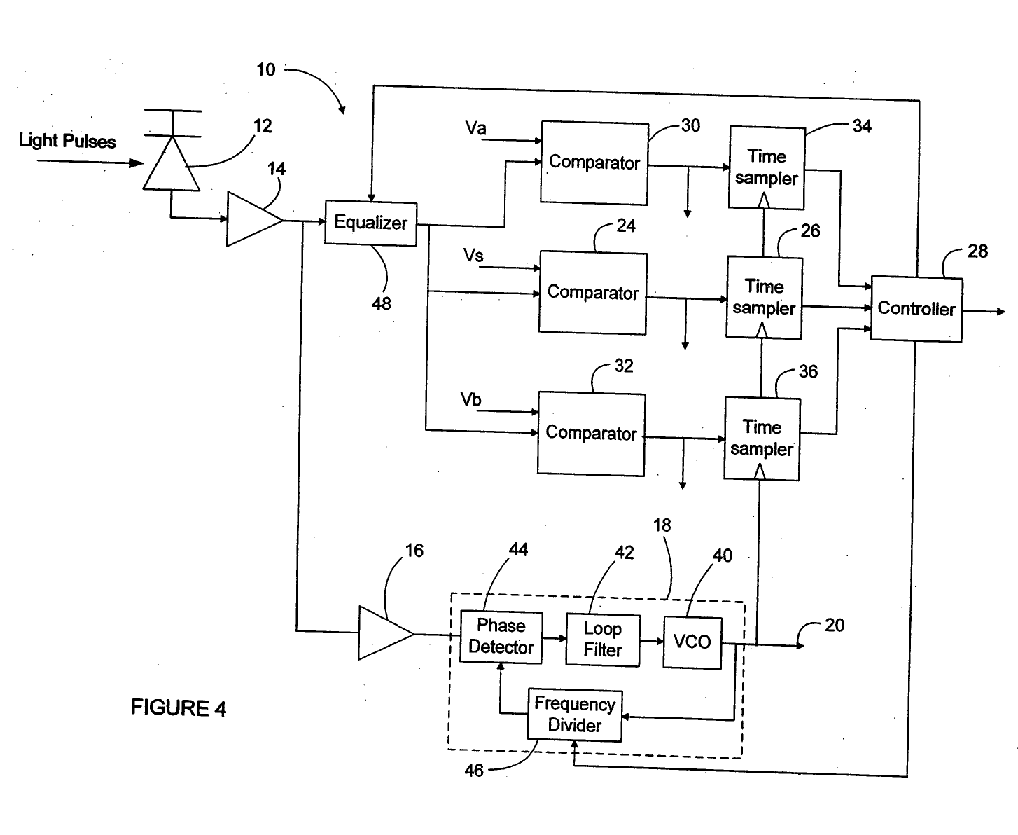

FIG. 4 is a block schematic diagram of an alternative receiver device, in accordance with the present invention. The receiver device shown in FIG. 4 is essentially the same as that shown in FIG. 1, and features which are indicated by common reference numerals have the same functions, and will not be described further.

As is conventional, the clock recovery unit 18 shown in FIG. 4 includes a phase-locked loop, which includes a voltage-controlled oscillator 40, a loop filter 42, a phase detector 44 and a frequency divider 46. If the voltage-controlled oscillator 40 begins operation generating a signal which is approximately equal to the desired frequency, then the phase-locked loop acts to ensure that the voltage-controlled oscillator 40 comes to generate a signal which is exactly equal to the desired frequency. However, if the voltage-controlled oscillator 40 does not begin operation generating a signal which is approximately equal to the desired frequency, then the phase-locked loop may not be able to operate correctly. In order to overcome this problem, the voltage-controlled oscillator 40 can be stepped through a number of initial frequencies, until it finds an initial frequency which allows it to lock onto the desired frequency.

This initial stepping may be controlled by using the separation of the outer thresholds, as described above, as a suitable controlled variable. If the correct initial frequency is selected, allowing the phase-locked loop to lock onto the desired frequency, then the separation of the outer thresholds will become relatively large. If any other initial frequency is selected, and the phase-locked loop is unable to lock onto the desired frequency, then the separation of the outer thresholds will be smaller.

The initial frequency of the voltage-controlled oscillator 40 can therefore be adjusted in such a way that the separation of the outer thresholds is maximised.

In the embodiment illustrated in FIG. 4, the invention is also applied to a receiver in which the amplifier 22 is replaced by an equalizer 48, in the form of a transversal filter. As is known to the person skilled in the art, a transversal filter includes delay elements, and the amount of delay introduced by each of these delay elements may be required to be equal to a given fraction of one bit period.

In accordance with the invention, therefore, the delay introduced by each delay element in a filter is a receiver parameter, which can be adjusted so that the separation of the outer thresholds, as described above, is maximised.

FIG. 4 therefore illustrates a receiver, in which the separation of the outer thresholds is used to control two independent receiver parameters. It will be apparent that use of the separation of the outer thresholds to control just one of these receiver parameters also falls within the scope of the invention.

It will also be apparent from these examples that there are other receiver parameters, which can be adapted in order to maximise the separation of the outer thresholds, and all such adaptations fall within the scope of the present invention.

The receiver of the present invention can therefore be adapted, in order to improve its performance, using the separation of the outer thresholds as a measure of signal quality, which can be calculated from measurements which are available in the receiver itself.

1. A method of detecting a received signal, the method comprising:
recovering a clock signal;
comparing the received signal with a centre threshold, and with at least one of a pair of outer thresholds;
forming digital samples of the received signal using the recovered clock signal;
adapting the values of the outer thresholds such that a constant proportion of the digital samples lie between the outer thresholds; and
adapting a receiver parameter such that a separation of the outer thresholds is maximised.

2. A method as claimed in claim 1, wherein the step of adapting the receiver parameter comprises adapting a phase of the recovered clock signal.

3. A method as claimed in claim 2, wherein the step of adapting the phase of the recovered clock signal comprises setting a sampling position at which digital samples are formed, and adjusting the sampling position to increase the separation of the outer thresholds.

4. A method as claimed in one of claims 2 or 3, wherein the step of recovering a clock signal comprises locking a voltage-controlled oscillator to the frequency of the received signal.

5. A method as claimed in claim 4, wherein the voltage-controlled oscillator is initially operated at a first frequency to recover the clock signal, the initial frequency being adjusted so that the separation of the outer thresholds is maximised.

6. A method as claimed in claim 2,
wherein the step of forming digital samples comprises integrating the received signal over successive bit periods, and
wherein the step of adapting the phase of the recovered clock signal comprises adapting the phases of the bit periods over which the received signal is integrated.

7. A method as claimed in claim 1, wherein the step of adapting the receiver parameter comprises adapting a delay introduced by a delay element in a filter.

8. A method as claimed in claim 7, wherein the delay introduced by a delay element is a fraction of one bit period.

9. A method as claimed in claim 8, wherein the filter is a transversal filter.

10. A method as claimed in claim 1, further comprising forming an output signal, wherein the output signal comprises a polarity bit based on the comparison between the received signal value and a centre threshold, and a confidence bit based on the comparison between the received signal value and the at least one of a pair of outer thresholds.

11. A receiver comprising:
a clock recovery unit, for recovering a clock signal;
at least one comparator, for comparing the received signal with a centre threshold, and with at least one of a pair of outer thresholds;
a sampler, for forming digital samples of the received signal using the recovered clock signal; and
a controller, for adapting the values of the outer thresholds such that a constant proportion of the digital samples lie between the outer thresholds, and for adapting a receiver parameter such that a separation of the outer thresholds is maximised.

12. A receiver as claimed in claim 11, wherein the controller is suitable for adapting the phase of the recovered clock signal.

13. A receiver as claimed in claim 12, wherein the controller is suitable for setting a sampling position at which digital samples are formed, and adjusting the sampling position to increase the separation of the outer thresholds.

14. A receiver as claimed in one of claims 12 or 13, wherein the clock recovery unit comprises a voltage-controlled oscillator, the clock recovery unit being adapted to lock the frequency of the voltage-controlled oscillator to the frequency of the received signal.

15. A receiver as claimed in claim 14, wherein the voltage-controlled oscillator is initially operated at a first frequency to recover the clock signal, the initial frequency being adjusted by the controller such that the separation of the outer thresholds is maximised.

16. A receiver as claimed in claim 12,
wherein the sampler is adapted to form digital samples by integrating the received signal over successive bit periods, and
wherein the controller is suitable for adapting the phases of the bit periods over which the received signal is integrated.

17. A receiver as claimed in claim 11, wherein the receiver further comprises a filter for filtering the received signal, the controller being suitable for adapting a delay introduced by a delay element in the filter.

18. A receiver as claimed in claim 17, wherein the delay introduced by a delay element is a fraction of one bit period.

19. A receiver as claimed in claim 18, wherein the filter is a transversal filter.

20. A receiver as claimed in claim 11, adapted to form an output signal, wherein the output signal comprises a polarity bit based on the comparison between the received signal value and a centre threshold, and a confidence bit based on the comparison between the received signal value and the at least one of a pair of outer thresholds.
